(19) United States
(12) Patent Application Publication
(10) Pub. No.: US 2015/0004685 A1
(43) Pub. Date: Jan. 1, 2015

(54) High Efficiency Continuous Micro Algae Bioreactor

(71) Applicant: David Wayne Carl, Alpharetta, GA (US)

(72) Inventor: David Wayne Carl, Alpharetta, GA (US)

(21) Appl. No.: 13/927,632

(22) Filed: Jun. 26, 2013

(51) Int. Cl. B01D 53/62; B01D 53/84

(52) U.S. Cl. CPC B01D 53/62; B01D 53/84
USPC 435/292.1

(57) ABSTRACT

This process is unique in that it provides a continuous photosynthetic bioreactor for carbon sequestration. An on-site bioreactor directly decreases the concentration of carbon dioxide in the emissions of fossil fuel consuming units. In this process, an algal medium is maintained in a bioreactor. Light is provided through artificial means. Nutrients are added in a cross flow pattern and waste products are removed as they are created, allowing for maximum growth of the algae.

### BACKGROUND OF THE INVENTION

1. Field of the Invention

This invention generally relates to a continuous biological gas cleaning system for removing carbon dioxide from the gas stream of fossil fuel burning devices.

2. Description of the Related Art

The U.S. produces nearly 2 billion tons of CO2 annually from the combustion of fossil fuels. CO2 has been theorized to be a major contributor to the greenhouse gas effect and is therefore the primary culprit in global warming. As fossil fuel consumption continues it is theorized that CO2 concentrations in the atmosphere could double in the near future.

For that reason many have investigated ways to capture and sequester CO2 emissions. Much work is being done in the area of solvent extraction of the CO2 and pumping it into salt mines or the ocean. This method is costly and it has not been proven that the CO2 will remain sequestered.

Another option involves sequestering the CO2 with biological reactors. Currently the primary methods are open shallow ponds and closed bioreactors. Both have their short comings. The use of shallow open ponds has these primary drawbacks. First, they require very large tracts of land for a typical fossil fuel burning electrical generating plant. Very few electrical generating plants have that amount of available land near them. Second, due to the large tract of land required, evening distribution of the flue gas and other nutrients throughout the pond such as to allow for efficient growth of algae is very difficult. Without proper distribution of nutrients the pond will grow in an inefficient manner requiring more acreage to accomplish the same goal. Third is the manner of temperature control. Optimum algal growth occurs over a temperature range of 80 to 90 degrees Fahrenheit. While it does grow in temperatures outside this range the growth rate is adversely affected. Shallow ponds will have their temperature largely influenced by the ambient temperature. In all but a few areas in the U.S., production would be severely limited in the winter and problematic during parts of the summer. Fourth, the ponds are only illuminated with natural light. This means they are only providing photosynthesis during days of sunlight. Therefore, during nighttime and overcast days there usefulness is limited. Those are some of the reasons why the use of shallow ponds for CO2 removal has not developed further.

Closed bioreactors also have several primary drawbacks. First is that they are very capital intensive. This is primarily because most are trying to use natural sunlight, so the reactor vessel must have a small diameter while also being opaque. The primary materials used for these vessels are glass or certain plastics. Neither of these provides a low cost option for manufacturing the reaction vessel. The second reason is that closed reactors allow for buildup of algal waste products. Because of these waste products the concentration of algae in the medium is limited. Most closed bio reactors that are in use are limited to algal concentrations of 1% or less. Low algal concentration increases the cost of ‘harvesting’ the algae. Doubling the algal concentration from 1% to 2% would reduce the expense of removing water by 50%. Third, since it is a batch reaction all elements required for reaction, except light, must be added to the vessel at the beginning of the process. Since some micro nutrients may be toxic to the algal solution in high concentrations and you are limited as to how much dissolved carbon dioxide can be in the solution, the entire process is limited.

Clearly, other means of sequestering CO2 are required.

### BRIEF SUMMARY OF THE INVENTION

The bioreactor is a large deep pond divided into separate channels. There are strands of lighting installed in each of the channels. Water and algae are added at point 2. Flue gas and other nutrients are added to the reactor at points (5) in each channel (6). As the water and algal medium progress through the pond the algae concentration increases. Therefore as the reaction progresses, more lighting and nutrients are required. This is accomplished by decreasing the spacing between the light strands and increasing the flow of flue gas and micronutrients.

### DETAILED DESCRIPTION OF THE INVENTION

The bioreactor shall be a concrete pond the exact dimensions of which are dependent on the amount of flue gas available. The depth of the pond must be a minimum distance of 5 feet to provide for sufficient time to absorb the CO2 and other flue gases into the water. To conserve space a depth of at least 10 feet is most practical. The main factors determining the length and width of the bioreactor are the amount of flue gas to be consumed and the algal species chosen. Many algal species have shown the ability to more than double their mass in a 24 hour period. A 500 Mega Watt electrical generating facility would require a bioreactor as small as a square 400 feet on each side.

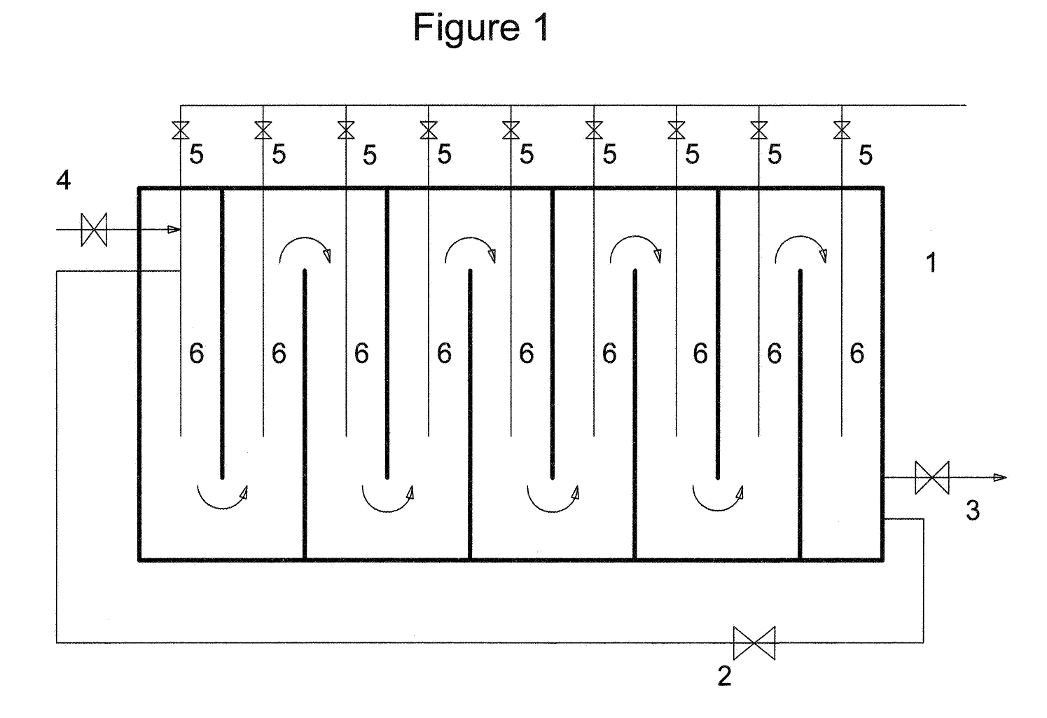

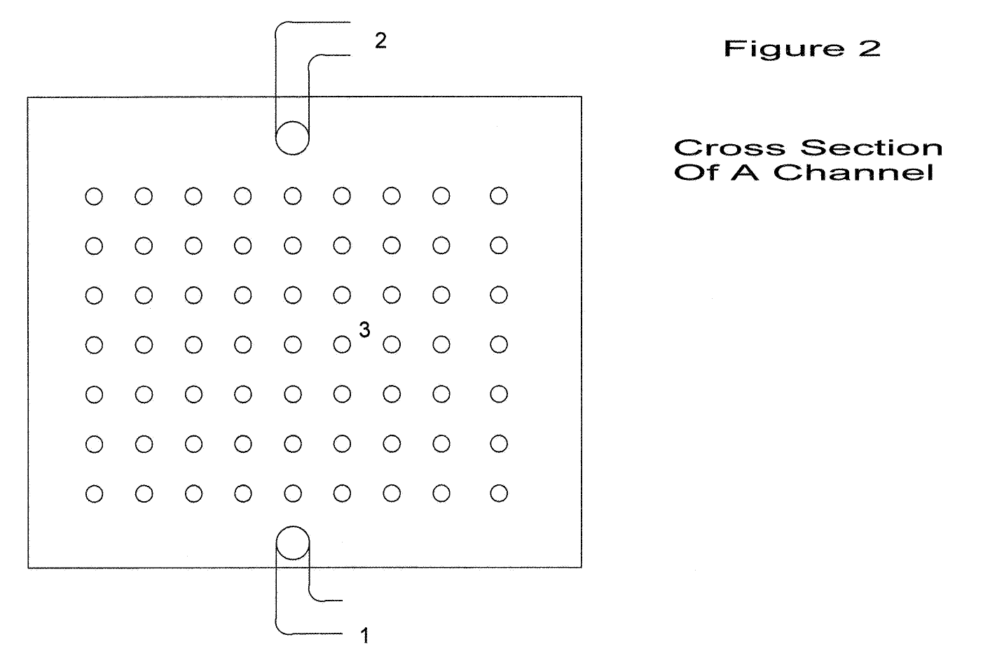

As shown on FIG. 1, water and algae are recirculated to the bioreactor via line (2). Nine channels are shown in FIG. 1, but the exact number would be determined by the magnitude of the source of carbon dioxide. A reactor 400 feet long would have as many as 40 channels. Nutrients are added at (5) along each channel (6). This is primarily the flue gas, but micronutrients will also be added at these points. This is shown more clearly on FIG. 2, as the flue gas is added at the bottom of the bioreactor (1) and micronutrients are added as a liquid solution at the surface (2). FIG. 2 also shows a typical spacing of lighting in the pond channel. As the reaction proceeds, the algae will absorb more light and the lights will need to be spaced closer together. The lighting will use LED's as this will minimize the electricity required to provide the light and enable the frequency to be tailored to the needs of the growth of the algal solution. Further, LED lighting will add the least amount of heat to the reactor. Excessive heat is detrimental to algal growth. Numerous studies have shown that the photosynthesis process does not use the entire light spectrum. The use of colored LED's, red and blue, will limit the introduction of light that will be poorly used by the algal medium. The algal concentration is to be twice as high at the exit of the reactor as it was at the entrance. Adding the nutrients in a cross flow pattern allows for greater quantities to be added to each subsequent channel. This assures that nutrients are always available for algal growth without having to provide them in high concentrations at the beginning of the reaction as is required in most closed bioreactors. Thus, the nutrients, macro or micro, do not become a limiting factor on the growth of the algal species. To achieve a similar growth in a batch process some nutrients would need to be added at such high concentrations that they could be toxic to the algae.

As the medium flows through the pond the algal concentration rises. This requires the addition of more nutrients per cubic foot of water to sustain the growth rate of the algal solution. Piping into the bioreactor will allow for controlling the nutrient flow from both the flue gas and the micronutrient solution.

Once the algal medium has traveled through the bioreactor it is necessary to remove or ‘harvest’ some of the algae. The harvesting process is not integral to the bioreactor so it is not described. Exiting the harvest process will be a mixture of water and algae. Algal cell walls are easily damaged. Throughout the process care is taken to avoid damage to the algal cells by minimizing agitation. Gravity flow will be utilized through the reactor. However, to return the post-harvest algal solution to the reactor requires some means of mechanical lifting. For this reason screw pumps will be used to return the algal solution to the entrance of the bioreactor. A concrete channel (FIG. 1 (2)) will then allow for the algal solution to gravity flow back to the bioreactor.

As the algae reproduces it creates waste products. The concentration of these waste products must be controlled to prevent detrimental effects on the algae. If the concentration of these waste products gets too high it can inhibit algal growth or even result in an algal kill. This is a limiting factor in closed bioreactors. The primary waste product from the photosynthesis process is oxygen. While oxygen is not per se toxic to algae, high concentrations of dissolved oxygen can inhibit nitrogen fixing by the algae and therefore decrease the growth rate. Removal of oxygen will occur naturally as the bioreactor is an open air reactor. Any excess oxygen will be released into the atmosphere. Other detrimental products can be removed from the bioreactor via a water purge (3) and the liquid volume regained through the makeup point (4). The water purge (3) will also serve as the harvest point for the algae.

What is claimed is:

1) An apparatus for removing carbon dioxide gas from fossil fuel burning sources, said apparatus is to be (a) an open air pond for growing an algal medium. This apparatus is to contain (b) a plurality of photosynthetic microbes, (c) a water and nutrient delivery device, (d) a light source device, (e) and a waste product removal system.

2) An apparatus in accordance with claim 1, further comprising a means to deliver a solution of micro nutrients to the reactor.

3) An apparatus in accordance with claim 1, further comprising a means for illuminating said photosynthetic microbe with a light source for a period of time.

4) An apparatus in accordance with claim 1, further comprising a means for removing the liquid solution from the reactor.

5) An apparatus in accordance with claim 1, further comprising a means for continuous operation of the bioreactor, 24 hours per day.
